(19) United States
(12) Patent Application Publication
(10) Pub. No.: US 2009/0024546 A1
(43) Pub. Date: Jan. 22, 2009

(54) SYSTEM, METHOD AND APPARATUS FOR PREDICTIVE MODELING OF SPATIALLY DISTRIBUTED DATA FOR LOCATION BASED COMMERCIAL SERVICES

(75) Inventors: Robert Ficcaglia, Redwood City, CA (US); Daniel Zapata, San Jose, CA (US)

Correspondence Address: PERKINS COIE LLP, P.O. BOX 1208, SEATTLE, WA, 98111-1208, US

(73) Assignee: MotivePath, Inc., Redwood City, CA (US)

(21) Appl. No.: 12/144,606

(22) Filed: Jun. 23, 2008

Related U.S. Application Data
(60) Provisional application No. 60/945,907, filed on Jun. 23, 2007.
(60) Provisional application No. 60/951,419, filed on Jul. 23, 2007.

(51) Int. Cl. G06F 15/18; G06N 5/02

(52) U.S. Cl. 706/12; 706/46

(57) ABSTRACT

A computer system implements a method to provide a class membership probability prediction based on collected usage data from a user device of a user. After device usage data, which contains location information, is collected from the user device, the collected usage data is processed to generate a predictive model by utilizing a machine learning algorithm. In response to a user input, a class membership probability estimation is produced by processing the user input through the probability predictive model. The resulted class membership probability estimation can then be used as a prediction of a demographic profile of the user.

### CROSS REFERENCE TO RELATED APPLICATION

The present application is related to and claims the benefit of priority of the following commonly-owned, presently-pending provisional applications: application Ser. No. 60/945,907 (Docket No. 64563-8001.US00), filed Jun. 23, 2007, entitled “System, Method and Apparatus for Predictive Modeling of Spatially Distributed Data”, of which the present application is a non-provisional application thereof; and application Ser. No. 60/951,419, filed Jul. 23, 2007, entitled “System, Method and Apparatus for Secure Sharing of Location Data”. The disclosures of the forgoing applications are hereby incorporated by reference in it entirely, including any appendices or attachments thereof, for all purposes.

### FIELD OF THE INNOVATION

At least one embodiment of the present invention pertains to a new method for aggregating spatially distributed data and producing a class membership probability estimation of a response indicator variable in an advertising, marketing, and/or retail transaction classification problem.

### BACKGROUND

There has been explosive growth in the numbers and quality of indexing and data mining techniques designed to organize web content, such as web pages and videos, primarily for the purpose of keyword searching. Known as “behavioral targeting”, search engine marketing and search engine optimization techniques have attempted to track user behaviors, activities, and preferences, in order to classify web content according to these consumer behaviors and preferences. These techniques are intended to produce more relevant search results, better advertising and marketing results, and ultimately, more profits for practitioners. Yet, these existing methods are failing to adequately model user behavior in the “offline”, physical, geographic world where consumers really exist.

In many industries, data is spatially distributed under many simultaneous environmental stimuli. For example, a consumer may carry his mobile phone, PDA, or smart-phone from home to work to social events, resulting in a spatially distributed mobile device usage pattern. Also, the consumer uses the mobile device from time to time, causing the device usage to be time variable. The mobile device's current or past location data set can be useful in providing more specific advertising messages to the consumer. Although many existing data mining and statistical analysis techniques have tried to provide spatial data analysis, these methods relied upon a vast collection of user location records.

Further, access to a user's location information is considered highly confidential. There is a perceived risk of abuse or excessive use by data owners and 3rd parties who wish to provide the user with offers related to commercial goods and services. Collection and use of location information typically require explicit permission of the network and the consumer for any marketing-purposed use or share. Once collected, these records are queried whenever the user presents a new location data point, and a selection from a corpus of messages or services is subsequently made. Without the user's persistent location data store, such data mining and statistical tests would be impossible. Further, these methods are data intensive and machine resource intensive, meaning that the more user location data is collected, the more machine data storage and processing time are needed for generating efficient indexes and query parameters from the collected location data.

Using of “masking” to hide a user's true identity might be effective in traditional behavioral targeting, where advertisers correlate the past records of web site visits to a real-time choice of advertisement messages. If an attacker or abusive marketer were to access a database of “masked” behavioral targeting data, i.e. data cleansed of any personally identifying monikers (e.g., Social Security Number, Date of Birth, etc), it would be difficult to uniquely identify a user from these data. However, given the highly specific nature of location data, the user's home, place of business, school, and those of their families are apparent. If made available in real-time or near real-time, this data could be used to track an individual and presents an array of privacy concerns. Even masking the SSN or user name would do little to protect the user's home or work address derived from the location data. As such, even a small amount of location data could be abused easily.

The use of data aggregation, where the individual user records are stripped of identifying information, is also an inferior method. During aggregation, counts of users that visit a location are used, and from that aggregate data, statistical or probabilistic inferences can be made. However, the user must first trust that the data collection and aggregation process does not leak sensitive information. Second, the value of that aggregate data is reduced as it cannot be used to predict the future location pattern of any individual, nor draw inferences as to the individuals whose demographic profiles and preferences are likely to bring them to a particular location. Thus advertisers and marketers are forced to base their messages and creative work on a crude demographic clustering of users, with overlapping needs and tastes.

Another current method of location based marketing is “beacon” based, where the user's current proximity to a “beacon” or broadcasting terminal allows the marketer to deliver a coupon or message. In reverse, the user could be broadcasting location and the terminal at a fixed location could receive the user's signal and begin the same transaction. This limits the marketer to messages that are short-lived, and therefore rapidly decline in value and relevance.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a system environment in which certain embodiments of the present invention can be implemented;

FIG. 2 illustrates a client device in which certain embodiments of the present invention can be implemented;

FIG. 3-A illustrates a function and data flow diagram in which certain embodiments the present invention can be implemented;

FIG. 3-B illustrates a Support Vector Machine in which certain embodiments the present invention can be implemented;

FIG. 4 illustrates a flow diagram showing predictive modeling of spatial distributed data;

FIG. 5 illustrates a flow diagram to perform data aggregation and transformation;

FIG. 6 illustrates a flow diagram showing generating of predictive models by using Support Vector Machine; and

FIG. 7 illustrate a flow diagram showing a market campaign based on predictive models.

### DETAILED DESCRIPTION

System, method, and apparatus for predictive modeling of spatially distributed location data, and for utilizing predictive models to provide targeted commercial services are described. In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

Location based marketing involves utilizing demographic profiles (selectors) derived from a consumer's or a business' location, to provide targeted advertising and marketing such as online display advertising, online interactive advertising, local search online advertising, searching engine marketing, and search engine optimization, etc. For example, a brick-and-mortar business is more willing to provide online advertisements to a mobile device user if it is aware that the potential customer is close-by, or will be close in the future. Or, an online business without brick-and-mortar presence may nevertheless be interested in web users that are deemed highly valuable based on their geographic locations. Rather than using traditional statistical data mining or direct data query algorithms to extract demographic profiles from large and persistent user location data stores, machine learning algorithms can be used to generate predictive models from a subset of training data. The predictive models can then be used to predict demographic profiles for advertisers without a persistent user or device location data store. Further, the predictive models shield user's current or past location information from the advertisers, thereby allowing utilization of the location data without directly sharing or revealing this information to the party who needs it.

In one embodiment, machine learning algorithms are used to generate predictive models from a volunteer group of client device usage data. The client device usage data contains time, geographic location, and/or activity information previously collected from one or more client devices. Machine learning algorithms are tools and techniques that allow computers to learn (extract rules and patterns) from the volunteer group of client usage data for training and testing of predictive models. Once the predictive model generation is completed, the models can then be applied to other users, and/or be adapted to fit the distinct and unique preferences and location patterns of an individual, without requiring the persistent use or sharing of subsequent location data.

Predictive models, or classifiers, can then be used to classify individual users into demographic profiles relevant to search marketing and mobile consumption. Based on certain inputs, a predictive model generates a class membership probability estimation to accurately predict, first, which class or classes a user belongs to, and second, a statistic probability of such classification being accurate. For example, given a mobile user's current location, a predictive model may provide a highly accurate probability determination on whether the user is a gourmet coffee drinker, or how likely the user would purchase coffee machine. A marketer may receive such probability determination of the user being a gourmet coffee drinker or coffee machine buyer, without direct knowledge of the user's current or past location.

A predictive model and its generated predictions can be then used as a form of demographic profile for a particular user, a group of users, a particular location, a specific business, and/or a combination thereof. The predicted demographic profile for a particular user can be used for selecting from a large number of possible advertisements ones that are highly relevant to the user's current and predicted future locations. Again, this allows not only complete privacy of the user's current and past location data, but provides highly effective targeting tools for marketers to deliver the best message to a user quickly.

The predictive models and their generated predictions can also be used to model which locations a given user or group is likely to visit. This is useful for an advertiser wishing to target their advertising message to several locations that a given user or group is likely to visit. For example, a luxury car retailer may wish to buy advertising that is displayed to a specific user demographic profile, urban professionals ages 20-30 of income >$75K, that is displayed at relevant sporting, dining, and shopping locations frequented by these individuals. Further, the predictive models also allow for asynchronous messages that are relevant to predicted future locations. Therefore, the user's interest can be sustained over longer periods of time, even though their current location could be nowhere near the target location, i.e. that of the advertiser or marketer.

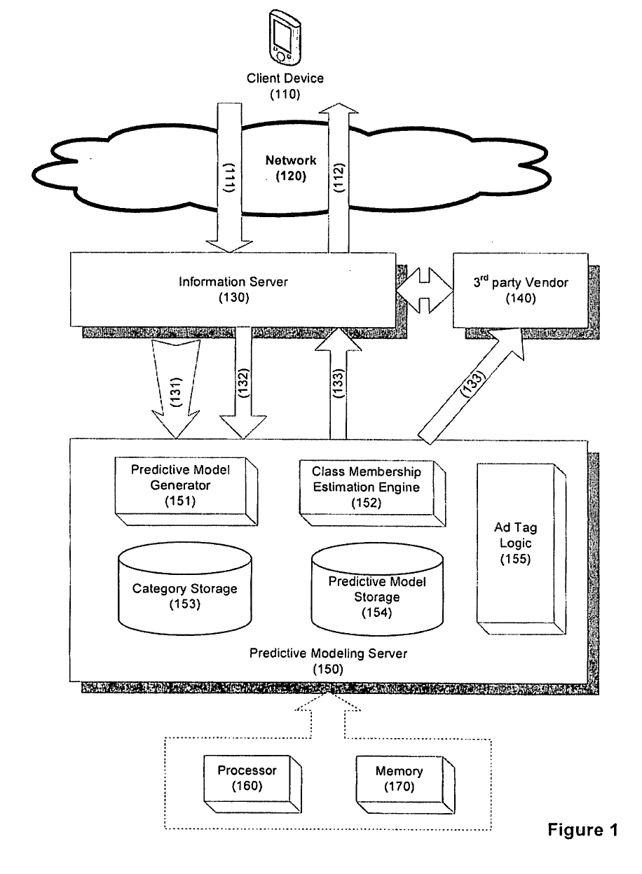

Referring now to FIG. 1, which shows an exemplary networked system environment in which the present invention may be implemented. In FIG. 1, a client device 110 communicates with an information server 130 via a network 120. The network 120 may be a wired network, such as local area network (LAN), wide area network (WAN), metropolitan area network (MAN), global area network such as the Internet, a Fibre Channel fabric, or any combination of such interconnects. The network 120 may also be a wireless network, such as mobile devices network (Global System for Mobile communication (GSM), Code Division Multiple Access (CDMA), Time Division Multiple Access (TDMA), etc), wireless local area network (WLAN), wireless Metropolitan area network (WMAN), etc.

The client device 110 refers to a computer system or a program from which a user request 111 may be originated. It can be a mobile, handheld computing/communication device, such as Personal Digital Assistant (PDA), cell phone, smart-phone, etc. The client device 110 can also be a conventional personal computer (PC), server-class computer, workstation, etc. In one embodiment, a client device 110 includes Global Positioning System (GPS) or similar location sensor that can track and transmit geographical location information.

In one embodiment, a user request 111 is sent, in wired or wireless fashion, from a client device 110 to an information server 130, and the information server 130 may return with a respond message 112 in response to the user request 111. Examples of user request 111 include HTTP requests originated from clicking of an ingress web hyperlink, a Wireless Application Protocol (WAP) hyperlink, a link embedded in a mobile terminated (MT) Short Message Service (SMS) message, or a link embedded in a mobile originated (MO) SMS message, etc. Respond messages 112 can be in similar forms and be transmitted in similar fashions.

In one embodiment, a user request 111 includes geographic location information collected from the client device 110. The geographic location can be directly provided by an embedded GPS or location sensor that tracks the real-time location of the client device 110. Alternative, the user request 111 can include information that can be used to derived geographic location. For example, a user may input his location information such as address or zip code into a user interface displayed on the client device 110. Or the user request 111 may include an IP address of the client device 110, which can be used to estimate a location by identifying a network service provider and the area the service provider serving the IP address. Similarly, by tracking the signals emanating from a mobile client device 110, a mobile phone tracker may accurately pinpoint the location of the mobile client device 110 within a 50-meter to 500-meter range.

In one embodiment, an information server 130 provides services to client devices 110 by processing various user requests 111 received from the client device 110, and responding directly or indirectly to these user requests. The information server 130 may contain a web server application such as Apache® HTTP Server, or Microsoft® Internet Information Server, etc, to process user requests in HTTP. Alternatively, the information server 140 may be a mobile phone service provider that offering phone, text messaging, email, packet switching for accessing the Internet, and other mobile services. In one embodiment, an information server 130 interacts with servers provided by internal or external 3rd party vendors 140.

In one embodiment, user requests 111 received from one or more client devices 110 are collected and saved as device usage data 131. The collected device usage data 131 are spatially distributed data that can be utilized for the modeling and training of predictive models. Device usage data 131 includes user registration, post-registration, service usage, installation & upgrading, downloading & uploading, navigating & purchasing, and/or other activities that have marketing significances. For example, collected device usage data may include a user's response to an invitation to a web or mobile service, which can be initiated by clicking a hyperlink embedded in a MO SMS message or voice call. Other examples of activities include MO SMS responses, voice interviews or answers to voice automated systems, submission of responses to email questionnaires or other web or mobile web page forms, etc. In one embodiment, location information associated with client devices 110 and user requests 111 are identified and stored with the collected usage data 131. Optionally, any other user identifying information and private data embedded in the collected device usage data 131 can be either cryptographically masked or discarded.

In one embodiment, the device usage data 131 based on user requests 111 are collected by an information server 130. The information server 130 can also collect implicit device usage data, such as activity log of background tasks performed by client devices 110 without user inputs. Examples of such implicit device usage data also include service heartbeat events submitted during communication with the information server 130, session state data, traces of the user's location over time, and/or session termination notification, etc. After collection, the collected device usage data 131 is transmitted to a predictive modeling server 150. Alternatively, client requests 111 can also be forwarded by the information server 130 to the predictive modeling server 150 or any third-party systems for collections.

In one embodiment, a predictive modeling server 150 is a system to perform predictive modeling on the collected device usage data 131. The predictive modeling server 150 includes a predictive model generator 151, a class membership estimation engine 152, a category storage 153, a predictive model storage 154, and/or optionally, an ad tag logic 155. In FIG. 1, the predictive modeling server 150 can be implemented as a server providing services to the information server 130 and 3rd party vendors 140. The predictive modeling server 150 can also be implemented as a component of the information server 130.

In one embodiment, the predictive model generator 151 performed predictive modeling on the collected device usage data 131 to generate, train, and test predictive models based on machine learning algorithms. The generated predictive models are then stored in the predictive model storage 154. Once predictive model generation is completed, the collected device usage data 131 is no longer needed. Because predictive models do not contain specific information about user's location information, discarding of the collected device usage data 131 would effectively render location information unrecoverable. Privacy information that can be derived from the location information is thereby protected. Details about the generating of predictive models by the predictive model generator 151 are further described below.

In one embodiment, the category storage 153 stores activity categories containing multiple aggregated hierarchical record set. A category may include one or more subcategories, and one category may be associated with multiple categories and subcategories. For example, a category “entertainment” may include subcategories such as “dining,” “music,” “theater,” etc. The same category may also be related to other categories such as “regions,” or “businesses,” etc. The category information stored in the category storage 153 can be used for mapping and modeling of the collected device usage data 131. It can also be used in conjunction with predictive models in generating class membership probability estimations. In one embodiment, activity categories stored in the category storage 153 can be obtained through 3rd party directory listing databases, review sites, entertainment portals, and search engines such as Yahoo® Directory.

In one embodiment, the predictive models previously generated are stored in the predictive model storage 154. Predictive models can be saved in the predictive model storage 154 in forms of mathematical formulas and their associated parameters. Predictive models can be associated with one or more users, client devices or locations. They can also be associates with one or more categories defined in the category storage 153. Details of the predictive models and the generation thereof are further described below.

In one embodiment, predictive models are used by a class membership estimation engine 152 to provide class membership probability estimations 133 based on a user input 132. A user input 132 is originated from a client device 110 as a user request 111. The user request 111 is either being forwarded by the information server 130 to the predictive modeling server 150, or being directly transmitted from the client device 110, or any other external systems not shown in FIG. 1, as a user input 132. Similar to the collected device usage data 131, the user input 132 contains activity information either explicitly generated from device usage, or implicitly collected by the client device 110 or the information server 130. In addition, except the location data, any embedded private demographic information is either masked or removed from the user request 111 before it being forwarded to the predictive modeling server 150. In one embodiment, the user input 132 is also being saved as a part of the collected device usage data 131 for predictive model generating.

In one embodiment, the class membership estimation engine 152 uses the information (location and other data) contained in the user input 132 to select one or more previously generated predictive models from the predictive model storage 154. The class membership estimation engine 152 then processes the user input 132, plus any additional information such as category definitions or 3^{rd} party vendor information, through the predictive models, in order to generate one or more class membership predictions. A class membership prediction provides a statistical probability estimation of an occurrence of a certain categorical action or a membership of a certain class. A class membership prediction can also be used to predict a future user location. For example, class membership predictions 133 can be a “30% probability to buy a new electronic device”, or a “25% chance to go to a specific store to redeem an online coupon,” etc. Therefore, the generated class membership probability estimations can be used as predicted demographic profiles unaware of any historical or current user location data.

In one embodiment, the class membership prediction can be used by an ad tag logic 155 to provide targeted commercial services to the information server 130. The targeted commercial services can then be returned by the information server 130 to a client device 110 as a part of respond message 112. The ad tag logic 155 manages advertisement messages as well as information related to marketers and advertisers, such as the address for their brick-and-mortar stores, etc. Targeted commercial services include advertisements, marketing messages, promotions, retail transactions, and/or retail fraud detection, etc. Based on some predicted demographic profiles, the ad tag logic 155 selects from a large number of possibly relevant advertisements one or more optimal messages that are highly relevant to the user's current and predicted future locations. The optimal messages are then transmitted as message 133 to the information server 130 to be presented on the client device 110 as message 112, or to any 3^{rd} party vendors 140 for further marketing campaign evaluations. Since the location information embedded in the user input 132 and/or the collected usage data 131 is not transmitted along with message 133, this approach not only protects the privacy of the user's current and past location data from being unnecessarily distributed, but also provides highly effective targeting tools for marketers to deliver the best message to a user quickly.

In one embodiment, class membership predictions generated by the class membership estimation engine 152 can directly be transmitted to the information server 130 or 3^{rd} party vendor 140 as messages 133. The information server 130 or 3rd party vendor 140 can customize their own targeted commercial services based on these predictions. Again, the location information embedded either in the user input 132 or in the collected usage data 131 is not unnecessarily distributed through message 133 to 3^{rd} party vendors. Details of the target commercial services are further described below.

In one embodiment, the predictive modeling server 150 includes one or more processors 160, memory 170, and/or other components. The processor(s) 160 may include central processing units (CPUs) for controlling the overall operation of the predictive modeling server 150. In certain embodiments, the processor(s) 160 accomplish this by executing software or firmware stored in memory 170. The processor(s) 160 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 170 is or includes the main memory of the predictive modeling server 150. The memory 170 represents any form of random access memory (RAM), read-only memory (ROM), flash memory (as discussed above), or the like, or a combination of such devices. In use, the memory 170 may contain, among other things, a set of machine instruments which, when executed by the processor 160, causing the processor 160 to perform embodiments of the present invention. In one embodiment, a predictive modeling server 150 is implemented with a computer system with sufficient processing power and storage capacities. Alternatively, the predictive modeling server 150 may be implemented with more than one computer system.

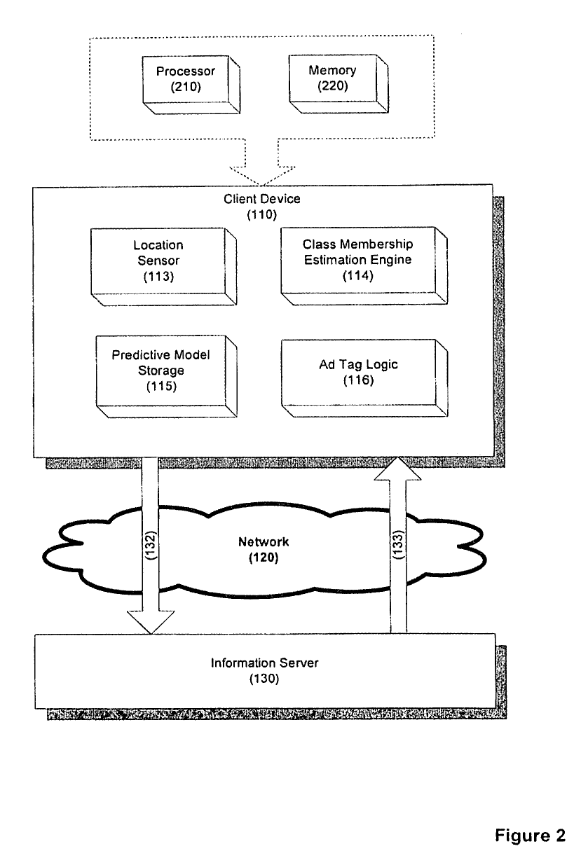

FIG. 2 illustrates an exemplary networked system environment in which the present invention may be implemented. In FIG. 2, a client device 110 includes a location sensor 113, a predictive model storage 115, a class membership estimation engine 114, and/or optionally an ad tag logic 116. In one embodiment, the client device 110 of FIG. 2 corresponds to a client device 110 of FIG. 1; the class membership estimation engine 114 of FIG. 2 corresponds to the class membership estimation engine 152 of FIG. 1; the predictive model storage 115 of FIG. 2 corresponds to the predictive model storage 154 of FIG. 1; and the ad tag logic 116 of FIG. 2 corresponds to the ad tag logic 155 of FIG. 1. Alternatively, components of FIG. 2 perform functions in addition to, or in lieu of, functions performed by corresponding components of FIG. 1, as described below.

Referring back to FIG. 2, in one embodiment, a client device 110 contains a location sensor 113, such as a GPS sensor or a WIFI detector with location estimation capability, to generate a real-time or near real-time location information of the client device. Alternatively, location information can be provided by a user of the client device 110, or be implicitly determined based on IP address, wireless signals, or mobile signals, as described above. In such a case, the location sensor 113 contains the necessary logic to extract from the user input, or derive from IP address or signals, the location information. To protect the privacy of the user, the detected location information is not transmitted out of the client device 110. Such approach is advantageous because it eliminates any possible leakage of the location information, therefore preventing misuse of such information by any party.

In one embodiment, predictive models similarly generated from collected usage data 131 of FIG. 1, as described above, are transmitted to a client device 110 of FIG. 2, and stored in a predictive model storage 115 of FIG. 2. Similarly, the predictive models can also be uploaded to or implemented in any devices or systems (not shown in FIG. 2) intended to perform similar predictive functions as describe herein. A class membership estimation engine 114 can select one or more predictive models from the predictive model storage 115, in order to process the location information collected from the location sensor 113 into one or more class membership predictions. The class membership predictions can then be passed to the ad tag logic 116 for selecting optimal advertisements to be displayed on the client server 110.

In one embodiment, advertisement information along with location information for the advertisers can be periodically loaded into the ad tag logic 116. Alternatively, the class membership predictions generated by the class membership estimation engine 114 can be transferred via a user request 132 to an information server 130, which is similar to the information server 130 of FIG. 1, or any other 3^{rd} party vendors not shown in FIG. 2, for additional location based marketing. Results of the additional location based marketing, such as an estimate of Return On Investment (ROI), etc, can be returned via a respond message 133 back to the client device 110. To protect user privacy, location information is not transmitted to the external of the client device 110 via the user request 132.

In one embodiment, the client device 110 includes one or more processors 210, memory 220, and/or other components. The processor(s) 210 may include central processing units (CPUs) for controlling the overall operation of the predictive modeling server 150. In certain embodiments, the processor(s) 210 accomplish this by executing software or firmware stored in memory 220. The memory 220 is or includes the main memory of the client device 110. In use, the memory 220 may contain, among other things, a set of machine instruments which, when executed by processor 210, causing the processor 210 to perform embodiments of the present invention.

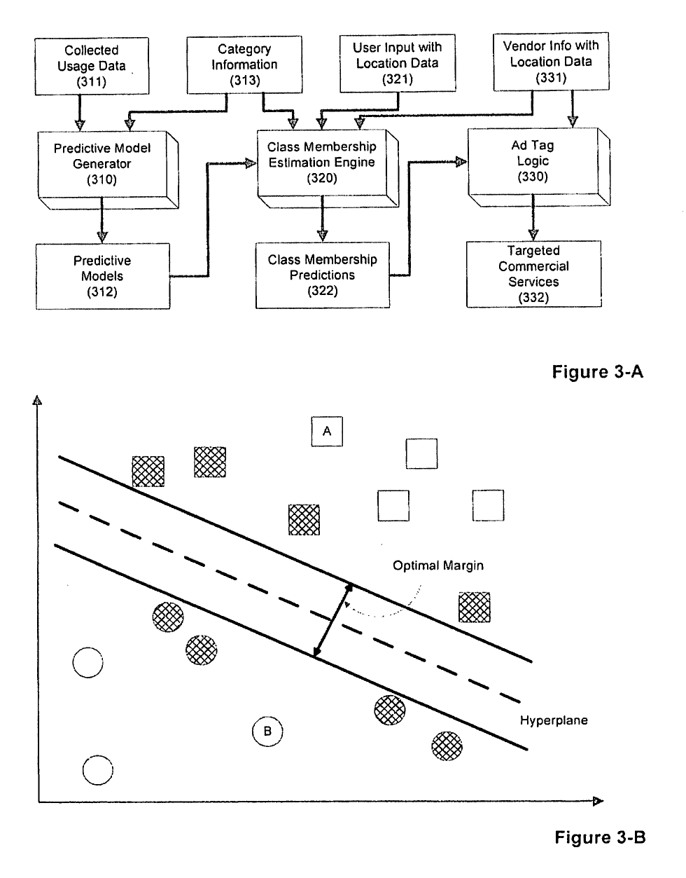

FIG. 3-A illustrates an exemplary function and data flow diagram in accordance with certain embodiments of the present invention. In FIG. 3-A, collected usage data 311 and category information 313 are inputted into a predictive model generator 310, in order to generate one or more predictive models 312. The generated predictive models 312 can then be inputted, along with category information 313, user input with location data 321, and/or vendor's information with location data 331, to a class membership estimation engine, in order to generate one or more class membership predictions 322. The class membership predictions 322 can be used standalone, transmitted to 3^{rd} parties not shown in FIG. 3-A, and/or be inputted along with vendor's information with location data 331 to an ad tag logic 322, for generating one or more targeted commercial services 332.

In one embodiment, collected usage data 311, along with category information 313 are inputted into a predictive model generator 310 to generate one or more predictive models. For example, assuming a large set of mobile device usage data is collected from one or more client devices 110 of FIG. 1. The collected mobile device usage data include time and location of the device usage, which reveals a concentration of device usage in a coffee shop during its regular business hour. The collected usage data 311 also include details of the activities that have been performed at the time of collection. Based on these collected usage data, the predictive modeling generator 310 could map such usage to behavioral preference categories 313, e.g., urban middle class, potential gourmet beverage consumers, etc, to generate a set of predictive models 312. The generated predictive models 312 do not reveal location information embedded in the collected usage data 311.

In one embodiment, the predictive models 312 can be used by a class membership estimation engine to predict potential behavior or demographic profiles of a new user. For example, assuming a new user input 321 containing a location is received. The received location indicates the user is currently in a local shopping mall. Based on the predictive models 312 and category information 313, a set of class membership predictions 322 can be generated by the class membership estimation engine 320. For example, the predictions 322 may indicate that the new user has a high probability of accepting online magazine subscription offers. Even if online magazine subscription data was never part of the collected usage data 311 used for generating the predictive models 312. Based on the location information embedded in user input 321, and category information 313 indicating a certain relationship between, for example, online behavior of urban middle class and the local shopping mall's typical customers, demographic-profile types of predictions 322 can be generated with a high level of certainty with the helps of machine learning algorithms, even though the predicted situation is novel and/or has never been analyzed.

In another embodiment, vendor information with location data 331 can be passed to the class membership estimation engine 320. Based on all the input data, a different set of class membership predictions 322 that are relevant to vendor's location data may be generated. For example, a class membership prediction 322 may reveal that a user, who originated the user input 321, has a higher probability to visit a store in San Jose, than a probability to visit a franchise store in San Francisco.

In one embodiment, vendor information 331 can also be passed to the ad tag logic 330 for generating targeted commercial services. For the above example, an online coupon for the San Jose store may be more relevant to the user in comparison to the same coupon for the San Francisco store. Thus a targeted online coupon for a similar, but different, store, located near San Jose, may be generated by the ad tag logic 330 and served as a targeted commercial service 332 to the user, or the user's mobile device. Alternatively, the ad tag logic 330 can generate a targeted commercial service without vendor information 331, or the class membership predictions 322 can be purchased or auctioned to any business who are interested in such predictions.

In one embodiment, targeted commercial services, including advertising, marketing, promotions, or retail transactions can be presented to a potential customer. Further, class membership predictions 322 can also be used for retail transaction fraud detections. A fraudulent transaction can be detected when a consumer's predicted demographic profile does not match his online or offline retail transactional patterns. For example, a demographic profile may predict a consumer being a seldom online shopper. Then an online shopping transaction originated from overseas would be highly suspicious.

FIG. 3-B illustrates an exemplary machine learning algorithm in accordance with one embodiment of the present invention. In one embodiment, a machine learning algorithm is adapted in generating predictive models from collected location usage data, so that the predictive models can be used in lieu of the collected location usage data.

In one embodiment, machine learning algorithms, such as Support Vector Machine (SVM), Fuzzy Neural Network (FNN), Bayesian Classifier, or Genetic Algorithm, etc, are tools and techniques capable of learning from observations and experiences based on training data sets. The rules and algorithms learned from experience data can then be utilized to predict outputs from new inputs. Machine learning algorithms are particularly effective at finding optimal or near-optimal solutions to problems with large numbers of decision variables and consequently large numbers of possible solutions. Examples of such problems include regression analysis, which is to analyze data consisting of values of inter-related variables, in order to predict, inference, test, and/or model the causal relationships among these inter-related variables. Another problem suitable for machine learning algorithms is classification, a statistic analytical tool in which individual data items are classified into groups based on quantitative information on one or more characteristics inherent in the data items.

One particular domain in which iterative machine learning algorithms such as FNN or SVM have had success is that of spatial data analysis. Spatial data analysis is to study the topological, geometric, or geographic properties of data, in order to determine the spatial distribution of agents under many simultaneous environmental stimuli. Location based advertising and marketing is a form of regression and classification challenges involving spatially distributed data such as mobile and stationary web usage. Machine learning algorithms such as SVM and/or FNN can simplify the computation requirements by classify users into demographic profiles (selectors) relevant to search marketing and mobile consumption.

Considering a binary classification problem given N pairs, {xₙ, yₙ} n in 1 . . . N over R²X {0,1} where the data point xₙ has to be classified as “not preferred” or “preferred” determined by yₙ=0 or yₙ=1, respectively. In the present discussion, the input space in R² are a set of 1 or more spatial coordinates, e.g. longitude and latitude per a specific cartographic projection, and the yₙ is a category measurement or indicator value over the set of categories and subcategories, e.g. a category “entertainment,” with subcategories “dining,” “music,” “theater.” The yₙ “preference” measurement is taken as either a count of the number of locations “tagged” with a given category or subcategory and then visited by a user, or a calculated measure of category relevance, e.g. keyword match measurement. Machine learning algorithms are especially effective in answering such binary classification problems.

FIG. 3-B illustrates an exemplary Support Vector Machine (SVM) which can be used to implement a machine learning algorithm. A SVM is a universal constructive learning procedure with a high performance in solving classification and regression problems. By providing mechanisms to classify spatially distributed data into regions below and above of some predefined levels of user behavioral preferences, A SVM can be used to predict user preferences by introducing novel choices and comparing to known measurements.

In one embodiment, a SVM is a mapping function ƒ(xₙ)=yₙ over all N inputs, and for any such n the xₙ lies as far away as possible from the decision surface ƒ=0. One suitable embodiment is implemented as a software program. For simplicity, assume that f is a linear function (i.e. ƒ=ax+b, for vector a and scalar b). Thus the decision surface ax+b=0 represents the “separating hyperplane” for classification, and the SVM finds the marginal distance from xₙ and the hyperplane, i.e. the SVM is the optimal solution to:

Maximize Σ: (w*xₙ+b)*yₙ>=Σ for all n and ∥wμ=1. (Scaling is not required, and in fact an equivalence for ∥w∥!=1 exists and is trivial to derive.)

In this form the xₙ of the solution represent the only data points required for satisfying the constraints of equality and are called the “support vectors,” and they alone determine the optimal solution. Of course, if f is not linearly separable, there are methods to introduce slack variables that can approximate the optimal solution. Thus, SVMs extend to non-linear functions (selectors) as kernel functions, Rⁿ X Rⁿ->R. Selection of the kernel function from a set of well-known candidates, or the construction of a novel kernel function is beyond the scope of this discussion. However, someone skilled in the relevant art will be capable of evaluating the utility of each of the standard candidates, or the evaluation of a novel candidate using Statistical Learning Theory and related disciplines. As will be appreciated, the specific choice of basis function and corresponding parameters can be determined based on the desired application. The primary value of the SVM (kernel function and support vectors) is its computational efficiency and other desirable attributes as described above.

In FIG. 3-B, a set of training vectors, illustrated as squares and circles, are mapped into a higher dimensional feature space. The process of generating a SVM involves the construction of a separating hyperplane in order to separate the training vectors into multiple classes. An optimal margin between the hyperplane and the training vectors ensures that the generated SVM can filter out certain “noise” input data. For an example as illustrated in FIG. 3-B, training vectors are separated by a hyperplane with an optimal margin into two classes, one being represented by circles, and the other being represented by squares. By using a kernel function, the determination of the hyperplane and the optimal margin can be carried out without intensive computation. As a result, only a subset of the training vectors is relevant in generating the SVM. The subset of training vectors is called support vectors, which are represented with cross patterns in FIG. 3-B.

Once generated, the SVM, which is represented by the hyperplane, optimal margin, support vectors, and kernel functions, is deemed as a form of predictive model. The solution hyperplane may be linear (as shown in FIG. 3-B) or non-linear. During class membership prediction, multiple attributes of a user input, such as time, location, activity, etc, are converted into a vector, and passed to the SVM predictive model. The predictive model generates a value, the sign (positive or negative) of the value representing whether the input vector being classified as any one of the classes. For example, if the value is positive, the input vector can be classified as being in the same class as the squares of FIG. 3-B. If the value is negative, then the input vector can be considered in a same class as the circles. In this example, the positive value may indicate that based on the input vector, the user is predicted to have a high probability of being in the same class as the squares, which representing, say, urban middle class.

In one embodiment, the generated predictive models are stored as one or more model functions and model parameters. The model functions can be in data-format, or be implemented as machine-executable instruments capable of being stored in storage mediums or being executed by a processor. The model parameters include kernel functions, weights, and other variables that can be used to customize or optimize the performance of a predictive model. The generated predictive models, with their parameters and functions, can be transferred or implemented in any system or device for performing its intended prediction functionalities.

In one embodiment, any machine learning algorithms, SVM being one of them, can be similarly used. Examples of such machine learning algorithms include FNNs, Genetic Algorithms, decision trees, etc. Other probabilistic classification and decision making algorithms, such as Bayesian, Kriging, etc, can also be used to generate similar predictive models for class membership probability estimation. Measured by prediction accuracy and performance efficiency for both resources (CPU, memory, data storage, etc), a SVM is generally a better choice for training of a classifier for spatially distributed data representing user location data. When a high level of accuracy is not required for certain predictions, any algorithm having similar or less performance than a SVM may also be used.

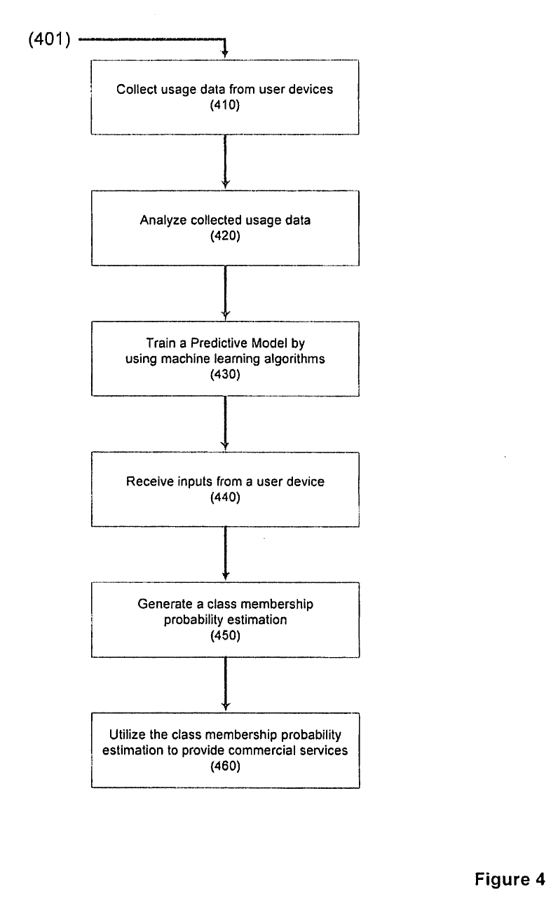

FIG. 4 illustrates an exemplary flowchart for a method 401 to perform predictive modeling of spatial distributed data, in accordance with certain embodiments of the present invention. The method 401 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 401 can be stored in memory 170, and/or be executable by a processor 160 of a predictive modeling server 150 of FIG. 1. Similarly, method 401 can be stored in memory 220 and/or executed by a processor 210 of a client device 110 of FIG. 2.

In one embodiment, at 410, transactional data is collected from user activities and interactions with a client device 110 of FIG. 1 and/or FIG. 2. User identifying information and private data, such as social security number, private phone number, etc, are generally not needed for generating predictive models. Therefore, if presented in collected usage data at 410, these privacy data should be cryptographically masked, securely hashed, or properly discarded. In one embodiment, all security practices described in the Open Web Application Security Project (OWASP) Mobile Working Group should be followed.

In one embodiment, data obtained at 410 includes time and location information explicitly or implicitly collected from one or more users' client devices. Because of the sensitive nature of the location information, prior user permission is generally required before collecting the usage data. Later on, after predictive models are generated, the previously collected usage data can be destroyed, thus eliminating any risk associated with potential information leakages. Such approach is also advantageous since it does not require large storage and processing needs in continuous analyzing and data-mining of the collected usage data during class membership predictions.

In one embodiment, location information is collected from a client device by user input, external or internal GPS tracing, and/or network (A-GPS) and on-device GPS positioning. Location information can be in a form of longitude and latitude; it can also be an address, zip code, or in other suitable formats. Similarly, time information can be determined by programs running on the client device, or by server receiving the client device transmissions. In one embodiment, time records are available as API calls in Windows Mobile OS, Palm OS, JavaME, Apple iPhone SDK, FlashLite, and/or an open source or proprietary mobile device software stack, etc. on the user's device. Server APIs for recording time exist in Java, PHP, and C, etc.

In one embodiment, user activities and transactions performed on a client device can be recorded in categorical and/or transactional formats. In categorical format, data is pre-associated with one or more categories and/or hierarchical subcategories, such as travel, shopping, entertainment, etc. In transactional format, data is stored as one or more transactions, such as page view, click, purchase, registration, cancellation, IM, SMS, MMS, etc.

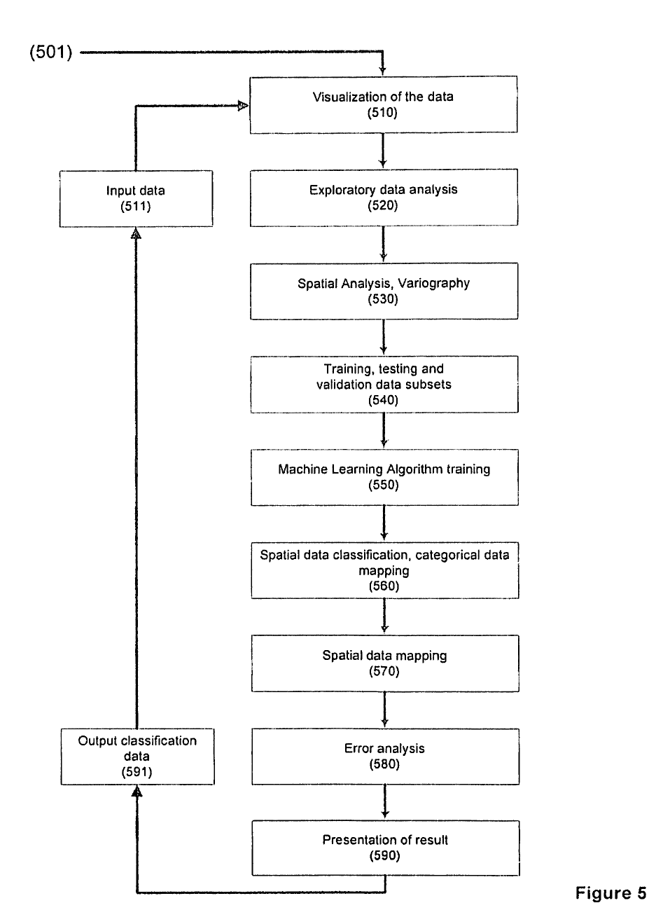

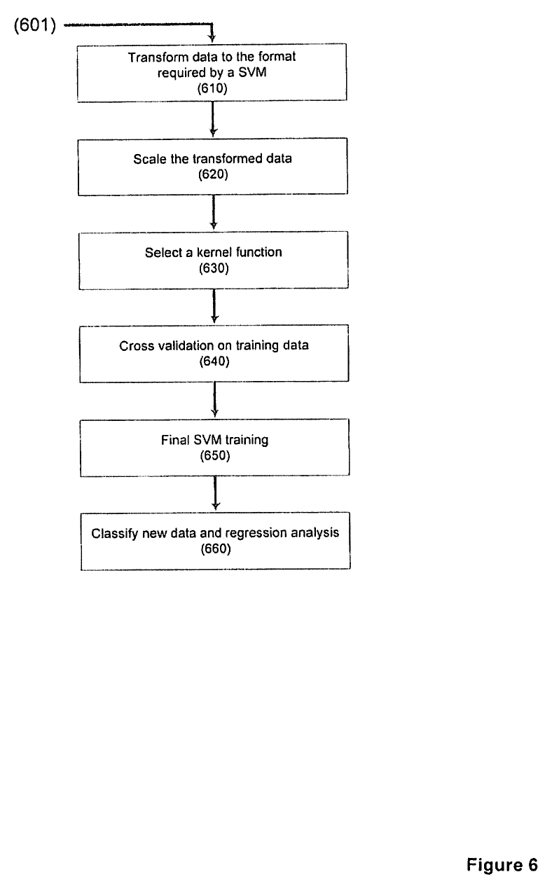

Referring back to FIG. 4, after the usage data is collected at 410, the collected usage data can be analyzed in aggregate. The aggregation and transformation of data are further described in FIG. 5. At 430, machine learning algorithms such as SVM, and/or FNNs can be selected for the generating of one or more predictive models based on the collected usage data. The details of predictive model generation are further described in FIG. 6.

Referring back to FIG. 4, in one embodiment, once the predictive models are generated at 430, the device usage data previously collected at 410 is no longer needed, and can be optionally discarded. At 440, new user inputs are received from a user device. As described above, the location information is also collected and transmitted along with these new user inputs. In an embodiment as illustrated in FIG. 1, the location information is transmitted first to an information server 130 and subsequently to a predictive modeling server 150. Alternatively, in an embodiment as illustrated in FIG. 2, the location information is not transmitted outside of the client device 110.

At 450, the location information in the user input is utilized by a predictive model to generate a class membership probability estimation. The class membership probability estimation provides probability predictions that could have certain commercial significance. Alternatively, the user input from 440 can be passed to multiple predictive models, in order to generate a variety of class membership predictions. For example, predictions based on user location data may indicate a user having a high probability in trying ethnic cuisine, purchasing tickets from local theaters, and/or ordering room services in a hotel, etc. A determination can be made based on these predictions to pick the best scenario in delivering location based marketing information. Or, a ROI analysis can be conducted based on these predictions. Predictions can be made not only on current location, but on predicted patterns of future locations for asynchronous messaging.

At 460, the one or more class membership probability estimations can be used for providing targeted commercial services to the user device of 440. In one embodiment, a class membership probability estimation may be a location-neutral demographic profile that is valuable for online and brick-and-mortar businesses. Alternatively, a class membership prediction may be either specific to the user's location, or specific to a business' location. Such predictions can be used to either tailor the targeted commercial services based on the user's current location, or be used to attract the user to the business' location with some targeted commercial incentives.

In one embodiment, the class membership probability estimations can be used to provide marketing campaign simulations. The system can also guide the advertisers through a “self-service” process of creating a branded, relevant, integrated user experience that conveys the advertiser's message in a useful way. In implementing such a marketing campaign, the advertiser must consider, and the system can graphically and logically represent, multiple end-user use cases and narratives, the end user profile segments (age, ethnicity, income, etc.) Content features, categories, user ranking, advertiser rankings, and content tile points (i.e., how the message is displayed).

FIG. 5 illustrates an exemplary flowchart for a method 501 to perform data aggregation and transformation, in accordance with one embodiment of the present invention. The method 501 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 501 can be stored in memory 170, and/or be executable by a processor 160 of a predictive modeling server 150 of FIG. 1.

In one embodiment, data aggregation is a process in which information is gathered and expressed in a summarized form, for purposes such as statistical analysis. Data transformation is to convert data from a source data format into a destination formation, in order to ensure that it has a normal distribution (a remedy for outliers, failures of normality, linearity, and homoscedasticity, etc.) Data transformation is usually done to prepare data for regression analysis, as it assumes that data are linear, normal and homoscedastic.

At 511, input data such as data collected from client devices, categorical data loaded from a categorical database, and activity data received from a behavioral targeting source are loaded. The input data is then passed to method 501 for processing. In one embodiment, not all the actions of 510-590 may be needed for data aggregation and transformation. Alternatively, the order of the aggregation and transformation can be different from the order of 510 to 590, as shown in FIG. 5. Other types of data or statistical analysis, such as sliding window statistical analysis, etc, can also be applied in additional to the ones shown in FIG. 5.

At 510, the data are presented for visualization, for understanding of the spatial clustering (results of preferential sampling) and representativity of the data. Visualization of the data also assists in discovering new relationships and spatial patterns. In one embodiment, data is mapped to a graph for manual or automatic visualization analysis. An example of visualization of data may convert the training data received from input data 511 into vectors to be mapped to a visualization space.

At 520, exploratory data analysis can be performed on the input data 511. For exploratory data analysis, the data collection is not followed by a model imposition, but by an analysis of the data—its structure, outliers, and suitable models. Exploratory data analysis techniques include scatter plots, histograms, bi-histograms, probability plots, mean plots, etc. Since all the data are present for analysis, there is no corresponding loss of information. Therefore, exploratory data analysis can ensure the validity of the data before further processing.

At 530, spatial analysis and variography can be performed. Spatial analysis is a statistics technique which studying data using topological, geometric, and/or geographic properties. Variography uses variogram models to describe the degree of spatial dependence of a spatial random field. Variograms can also be used to determine the spatial “roughness” of the data, or be used to discover neighborhoods from nominal data measurements. At 540, the data is splitted into training, testing, and validation subsets. The training data would be used for generating and training of predictive models. The testing data would be used for fine-tuning of the trained predictive models, and the validation data would be used for validating whether the models can accurately predicts results for known inputs and outputs. In case of clustered data, spatial de-clustering procedures can be used to perform action 540.

At 550, a machine learning algorithm is selected for training based on the training data set configured at 540, in order to generate predictive models. Difference machine learning algorithms can be used for such training. Based on different type of spatially distribute data, cost-benefit analysis could be used to find an optimal machine learning algorithm based on measures of precision, accuracy, computational efficiency, and ease of automation. In one embodiment, based on the performance and accuracy of its predictions, a SVM can be used to generate predictive models for spatial distribute data with location information, in order to provide class membership predictions without revealing sensitive location information. Alternative, Bayesian inference, Kriging, and other spatial regression analysis methods can be used as machine learning algorithms. These algorithms provide useful relationships, but are less scalable, with greater error or significantly more manual efforts. Details of using a SVM to perform 550 are further described in FIG. 6.

Referring back to FIG. 5, at 560, spatial data classification and categorical data mapping can be performed on the result data generated by predictive models trained at 550. Classification of data into one or more categories and subcategories also helps mapping such data into a numerical data space before being the data being utilized by machine learning algorithms, before the building and testing of machine learning algorithms at 550. At 570, spatial data mapping, or spatial regression can be performed on the predictive models outputs to further captures the relationships among the inputs or outputs. At 580, error analysis can be used to determine the error or uncertainty in the outputs in order to fine-tune the learning machines. Results of error analysis will be determined by comparing statistics for estimation error between different machine learning algorithms. Examples of estimation error measures include, mean, median, maximum, lower and upper quartile, standard deviation, skewness, kurtosis, etc. A finding of a favorable error estimation can be considered a favorable result. And at 590, output data are presented to the users, either visually or in other means. Alternatively, output classification data 591 presented from 590 is itself an input parameter to a multivariate function, which can be feed-back the method 501 as a part of input data 511.

FIG. 6 illustrates a flow diagram showing generating of predictive models by using a SVM, in accordance with certain embodiments of the present invention. At 610, training, testing, or validating dataset are transformed into the format of a SVM. At 620, the transformed data is scaled into a uniform unit of measurements. At 630, multiple kernel transformation functions can be selected and tested. Examples of kernel transformation functions include polynomial kernels, n-layer perceptrons, or RBF kernel K(x, y)=e−kx−yk2, etc. At 640, cross validation (leave-k-out) can be used to find the best parameters. At 650, the best parameters and kernel function, which define predictive models, are used to train the whole training set. Afterward, at 660, new test data can be introduced into the defined predictive models for further regression analysis.

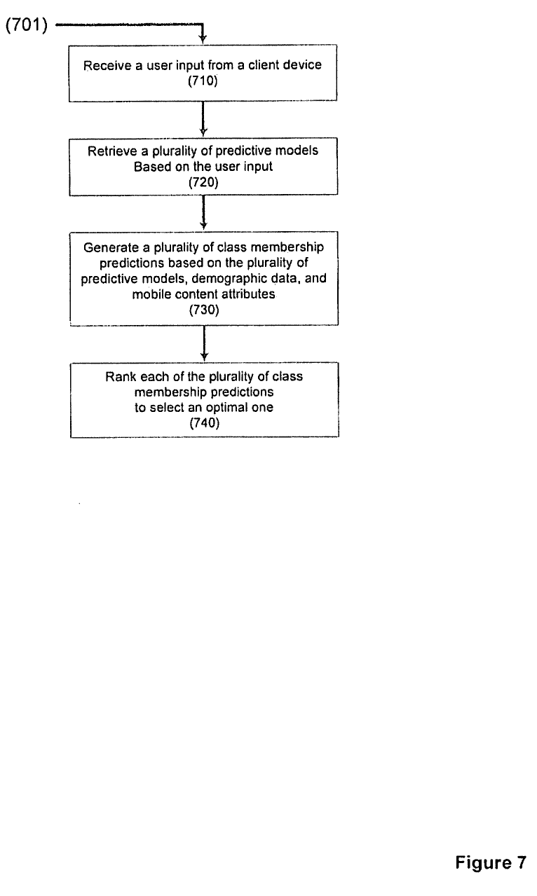

FIG. 7 illustrate a flow diagram showing a targeted location based marketing based on predictive models, in accordance with certain embodiment of the present invention. The method 701 may be performed by processing logic that may comprise hardware, software, firmware or a combination thereof. In one embodiment, method 701 can be stored in memory 170, and/or be executable by a processor 160 of a predictive modeling server 150 of FIG. 1, or be stored in memory 220, and/or be executed by a process 210 of a client device 110 of FIG. 2.

Referring back to FIG. 7, in one embodiment, at 710, a user input is received from a client device similar to the client device 110 of FIG. 1. The user input may or may not contain location data. At 720, based on the user input and the embedded information, a plurality of predictive models are retrieved. At 730, a plurality of class membership predictions are generated based on the plurality of predictive models, the user input, any other demographic data or mobile content obtained from an advertiser. The purpose is to guide the advertiser through the process of creating a branded, relevant, integrated user experience that conveys the advertiser's message in a useful way. Therefore, the advertiser must consider, and the system must graphically and logically represent, the following demographic data to be inputted to the predictive models: end user use cases and narratives; end user profile segments (age, ethnicity, income, etc); content features, categories, user rankings, advertiser rankings; content “tile points”; budget (cost per conversion, volume estimate on expected conversions); ROI estimates (conversion rate), simulated campaign and test environment, deployment status and reporting, etc.

For mobile contents to be inputted into the predictive models, the following user cases can be evaluated for the purpose of integration: Create, Read, Update, and Delete (CRUD) ad user, campaign, account; CRUD end user profile (EP); query content; integrate with the account server to CRUD budget, including payment info or integration with 3rd party payment gateway; query the predictive model for RPO estimates; act as an ad vector application and simulate the end-end experience; provide interface for advertiser reporting; Afterward, at 740, the plurality of predictions, generated by inputting the above data into the predictive models, can be considered as multiple marketing and/or campaign scenarios. These “what-if” scenarios can be further analyzed and transformed into pivot tables and charts displaying data across all model dimensions. Or the scenarios can be projected onto timelines for system and user events. Further, additional categorizing, ranking, indexing and pipelining can be used to further classifying the outcomes. Based on these outcomes, user responses to the marketing efforts, or the conversions rates can be accurately forecasted, and appropriate budgets can be allocated. In one embodiment, additional marketing and/or campaign activities can be performed at 740. These activities include CRUD model simulations; reviewing and approval of new or updated mobile content that is classified by the predictive models; and/or deployment tracking of sponsored contents; etc.

In one embodiment, a user input at 710, with or without embedded current location data, can be used for retrieving one or more probability predictive models, either from a user device, or from a predictive modeling server. The retrieved predictive models can then be used with the user input, and possibly additional categorical or other inputs, to predict one or more user's demographic profiles. Based on the one or more predicted demographic profiles, 740 could classify, rank, and/or select high relevant marketing, advertising, and/or retail transaction messages for that user. The current location data, if embedded in the user input, is not transmitted to any 3rd parties.

In one embodiment, a user input at 710, without embedded location data, can be used for retrieving multiple predictive models, and for predicting multiple demographic profiles with respect to physical locations. And the multiple demographic profiles can be used to classify, rank, and/or select high relevant physical locations or geographic areas for the user. Such approach is advantageous to predict the user's current location, or to select a business with a location close to the predicted location for targeted commercial services. The predicted current location data is not transmitted to any 3rd parties.

In one embodiment, a user input at 710, with embedded current location data, can be used for retrieving multiple predictive models, and for predicting multiple demographic profiles with respect to novel relevant locations. And for a given predictive model at a predicted location, a classification and/or ranking can be made to select high relevant future locations or geographic areas for the user over a period of time. Such approach is advantageous to predict the user's future location, or to select a business with a location close to the predicted future location, for targeted commercial services. The embedded current location and the predicted future location are not transmitted to any 3rd parties.

In one embodiment, a user input at 710, with embedded current location data, can be used for retrieving multiple predictive models, and for classifying physical locations according to the best match with a user or a group of user's demographic profile for fraud detections. And for each predicted or classified physical location, a ranking can be made to sort the relevant physical locations and geographic areas for these users. Such approach is advantageous to detect retail transaction fraud with respect to a user, a group of users, a specific location or area, and a combination thereof.

Thus, systems, methods and apparatus for predictive modeling of spatially distributed data have been described. The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, or a “machine-readable storage medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method, comprising:
processing usage data collected from a user device of a user, wherein the collected usage data contains location information;
generating a predictive model from the collected usage data by utilizing a machine learning algorithm;
in response to a user input, producing a class membership probability estimation by processing the user input through the predictive model, wherein the class membership probability estimation predicts a demographic profile of the user.

2. The method as recited in claim 1, further comprising:
initiating targeted commercial services to the user device based on the predicted demographic profile.

3. The method as recited in claim 1, further comprising:
producing a return on investment (ROI) estimation based on the predicted demographic profile.

4. The method as recited in claim 1, further comprising:
producing a user behavior simulation for marketing and advertising campaigns based on the predicted demographic profile.

5. The method as recited in claim 1, wherein the collected usage data further contains private demographic data of the user, the private demographic data being optionally cryptographically secured.

6. The method as recited in claim 1, wherein the predictive model does not contain the location information contained in the collected usage data, and the collected usage data can be optionally discarded upon the completion of the generating of the predictive model.

7. The method as recited in claim 1, wherein the class membership probability estimation classifies the user into one or more classes.

8. The method as recited in claim 1, wherein the class membership probability estimation provides a probability of the user being in one or more classes.

9. The method as recited in claim 1, wherein the user input contains a current location of the user device, the predicted demographic profile not containing the current location of the user device.

10. The method as recited in claim 1, wherein the user input contains a business location, the predicted demographic profile predicting a user preference with respect to the business location.

11. The method as recited in claim 1, wherein the user input does not contain location information, and the predicted demographic profile provides a geographic location relevant to the user.

12. The method as recited in claim 1, wherein the class membership probability estimation is associated with a predefined class category.

13. The method as recited in claim 1, wherein the processing of the usage data comprising:
optionally visualizing the usage data;
optionally performing comprehensive exploratory data analysis; and
optionally performing comprehensive exploratory structural analysis and modeling of anisotropic spatial correlation.

14. The method as recited in claim 1, wherein the processing of the usage data comprising:
splitting the usage data into training, testing and validation subsets;
utilizing the training subsets to train the predictive model;
utilizing the testing subsets to test the trained predictive model; and
utilizing the validation subset to validate the tested predictive model.

15. The method as recited in claim 1, wherein the machine learning algorithm is a Support Vector Machine (SVM).

16. The method as recited in claim 15, wherein the generating of the predictive model further comprising:
transforming the processed usage data to a SVM implementation format;
conducting scaling on the processed usage data;
testing multiple model parameters and kernel transformation functions;
using cross-validation to find optimal parameters for the multiple kernel transformation functions; and
using the optimal parameters to train the predictive model.

17. The method as recited in claim 1, wherein the machine learning algorithm is a probabilistic classification and decision making algorithm.

18. The method as recited in claim 1, wherein the method is embodied in a machine-readable medium as a set of instructions which, when executed by a processor, cause the processor to perform the method.

19. A method, comprising:
receiving a user input from a user device of a user;
retrieving a plurality of pre-generated predictive models, wherein the plurality of predictive models are related to the user input;
generating a plurality of class membership probability estimations by processing the user input through the plurality of pre-generated predictive models; and
selecting an optimal class membership probability estimation from the plurality of class membership probability estimations, wherein the optimal class membership probability estimation predicts a demographic profile of the user.

20. The method as recited in claim 19, further comprising:
providing targeted commercial services to the user device based on the predicted demographic profile.

21. The method as recited in claim 19, wherein the plurality of predictive models are generated based on usage data previously collected from one or more user devices, the usage data contains location information of the one or more user devices, the plurality of predictive models do not contain the location information, and the collected usage data can be optionally discarded upon the completion of the generating of the plurality of predictive models.

22. The method as recited in claim 19, wherein the user input contains location information obtained from the user device, and the predicted demographic profile does not contain the location information.

23. The method as recited in claim 19, wherein the user input does not contain location information, and the predicted demographic profile predicts a physical location for the user.

24. The method as recited in claim 19, wherein the user input contains location information obtained from the user device, and the predicted demographic profile predicts a future location for the user over a period of time.

25. The method as recited in claim 19, wherein the optimal class membership probability estimation is selected based on a probability of predicting a commercial location for the user.

26. The method as recited in claim 19, wherein the optimal class membership probability estimation is selected by ranking a probability value for each of the plurality of class membership probability estimations.

27. The method as recited in claim 19, wherein the method is embodied in a machine-readable medium as a set of instructions which, when executed by a processor, cause the processor to perform the method.

28. A device, comprising:
a location sensor to obtain location information of the device;
a class membership estimation engine coupled with the location sensor, wherein the class membership estimation engine generates a class membership probability estimation based on the location information and a predictive model, the predictive model being selected from a plurality of pre-generated predictive models; and
a commercial service engine coupled with the class membership estimation engine, to initiate targeted commercial services to the device based on the class membership probability estimation.

29. The device as recited in claim 28, wherein the location information is not transmitted out of the device.

30. A system, comprising:
a predictive modeling engine to generate a plurality of predictive models from collected device usage data, wherein the collected device usage data contains location information; and
a class membership estimation engine coupled with the predictive modeling engine, wherein the class membership estimation engine generates a class membership probability estimation based on a user device location information and a predictive model selected from the plurality of predictive models.

31. The system as recited in claim 30, wherein the user device location information and the location information contained in the collected device usage data are not transmitted out of the system.
